(19) United States
(12) Patent Application Publication
(10) Pub. No.: US 2012/0208502 A1
(43) Pub. Date: Aug. 16, 2012

(54) SYSTEMS AND METHODS FOR EXTENDED/ENHANCED LOGICAL INTERFACE BEHAVIOR

(75) Inventor: Michelle Perras, Montreal (CA)

(73) Assignee: InterDigital Patent Holdings, Inc., Wilmington, DE (US)

(21) Appl. No.: 13/367,639

(22) Filed: Feb. 7, 2012

Related U.S. Application Data
(60) Provisional application No. 61/441,895, filed on Feb. 11, 2011.

(51) Int. Cl. H04W 28/02; H04W 12/06

(52) U.S. Cl. 455/411

(57) ABSTRACT

Systems, methods, and instrumentalities are disclosed to configure a mobile node. A mobile node may receive a configuration message. The configuration message may be received from an access network discovery and selection function (ANDSF), which may be part of an open mobile alliance device management (OMA DM) server. The configuration message may comprises a mobile node rule. The mobile node may change a configuration of the mobile node in accordance with the mobile node rule. The mobile node rule may indicate that the mobile node is to transmit uplink packets on a certain interface. The mobile node may transmit an uplink packet over the interface indicated by the mobile node rule.

### CROSS-REFERENCE TO RELATED APPLICATIONS

This application claims the benefit of U.S. Provisional Patent Application No. 61/441,895, filed on Feb. 11, 2011, the contents of which are hereby incorporated by reference herein.

### BACKGROUND

Network based IP flow mobility may refer to how data flows are handled by network entities. Currently, there are problems in managing data flows.

### SUMMARY OF THE INVENTION

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Systems, methods, and instrumentalities are disclosed to configure a mobile node, which may include configuring a logical interface (LIF) associated with the mobile node. A mobile node may receive a configuration message. The configuration message may be received from an access network discovery and selection function (ANDSF), which may be part of an open mobile alliance device management (OMA DM) server. The configuration message may comprises a mobile node rule. For example, the configuration message may indicate how the mobile node is to handle an incoming flow or an outgoing flow (e.g., an interface to use, a processing method, etc.). The configuration message may be an open mobile alliance device management (OMA DM) message. The configuration message may be based on feedback from the mobile node. The configuration message may comprise an action and a parameter.

The mobile node may change a configuration in accordance with the mobile node rule. The mobile node rule may indicate that the mobile node is to transmit uplink packets on a certain interface. The mobile node may transmit an uplink packet over the interface indicated by the mobile node rule. As an example, before receiving the configuration message, the mobile node may have been configured to transmit uplink packets on a physical interface on which an associated downlink packet was received. In response to the received configuration message, the mobile node may transmit uplink packets on a physical interface that is different than the one on which an associated downlink packet was received.

Configuration of the mobile node may be implemented by an anchor node, such as a local mobility anchor (LMA). OMA DM server functionality may be implemented at the anchor. The mobile node rule in the configuration message may agree with a related anchor node rule or may be different than the related anchor node rule.

The mobile node rule may be one of a plurality of mobile node rules. The plurality of mobile node rules may be prioritized. For example, the prioritization may be based on one or more of the following: a data type, a time of day, or a cost.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an another example radio access network and an another example core network that may be used within the communications system illustrated in FIG. 1A;

FIG. 1E is a system diagram of an another example radio access network and an another example core network that may be used within the communications system illustrated in FIG. 1A;

FIG. 2 illustrates an exemplary logical interface implementation;

FIG. 3 illustrates an exemplary flow diagram of a network-controlled IP flow mobility sequence;

FIG. 4 illustrates an exemplary flow diagram of phases of a device management protocol;

FIG. 5 illustrates an exemplary encoding format;

FIG. 6 illustrates an exemplary encoding format; and

FIG. 7 illustrates an exemplary encoding format.

### DETAILED DESCRIPTION

A detailed description of illustrative embodiments may now be described with reference to the figures. However, while the present invention may be described in connection with exemplary embodiments, it is not limited thereto and it is to be understood that other embodiments may be used or modifications and additions may be made to the described embodiments for performing the same function of the present invention without deviating therefrom. In addition, the figures may illustrate call flows, which are meant to be exemplary. It is to be understood that other embodiments may be used. The order of the flows may be varied where appropriate. Also, flows may be omitted if not needed and additional flows may be added.

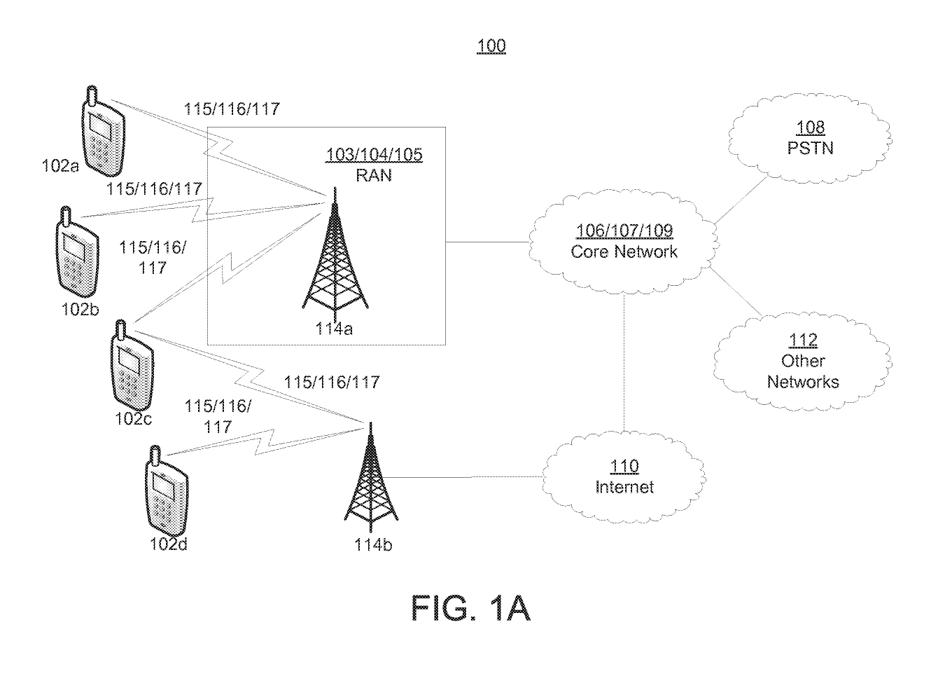

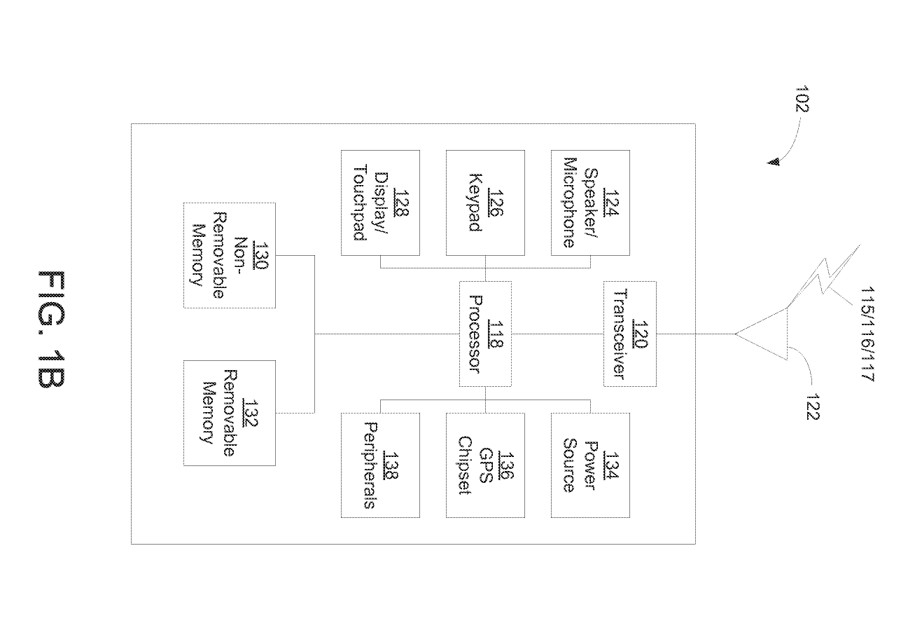

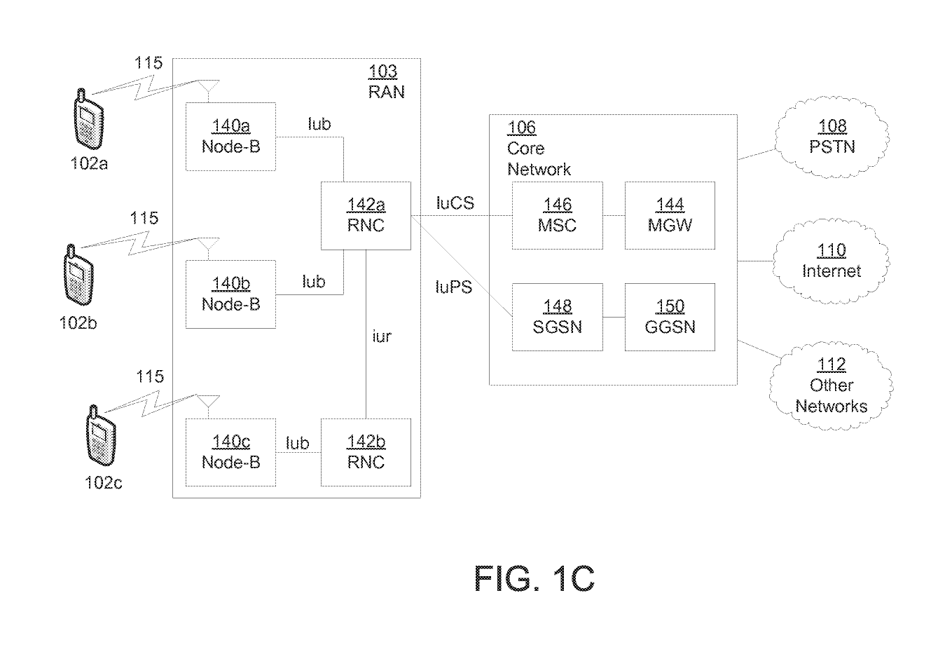

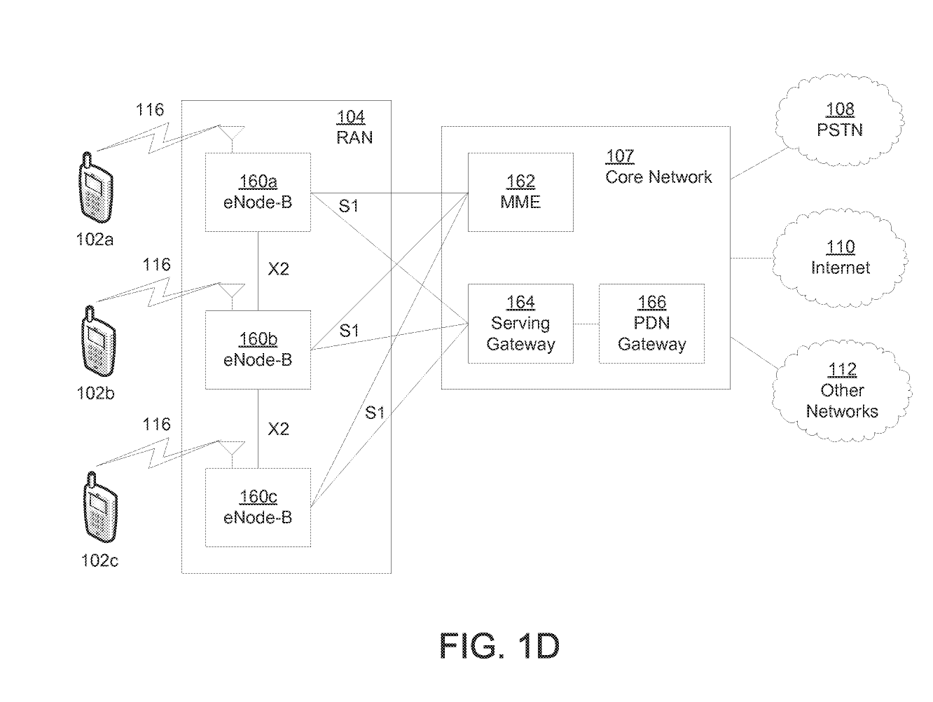

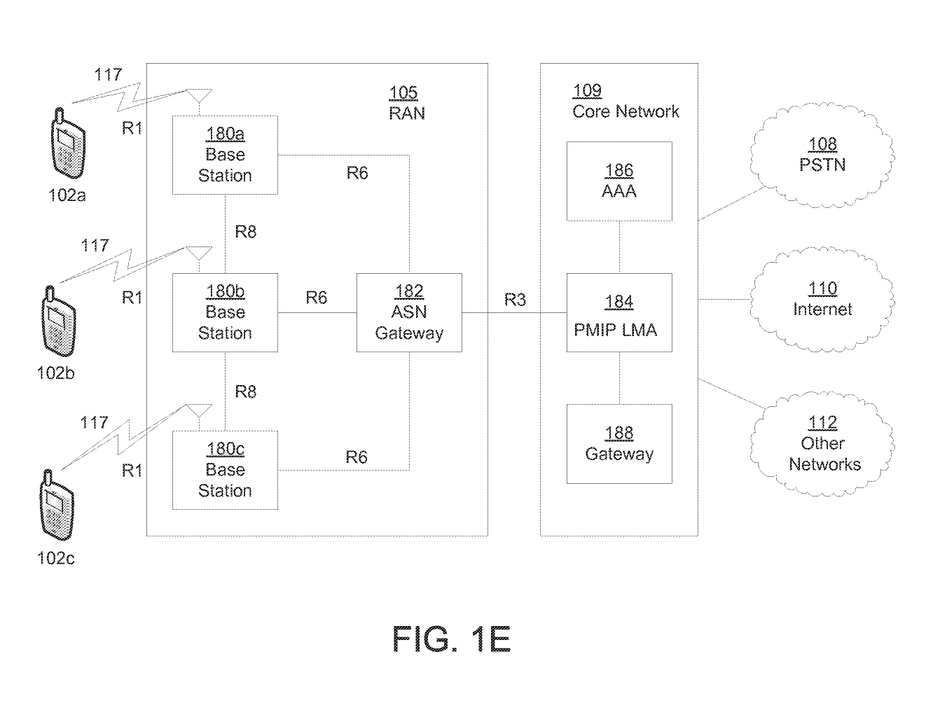

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA). In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a Proxy mobile IP Local Mobility Anchor (PMIP-LMA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The PMIP-LMA may be responsible for IP address management, and may enable the WTRUs 102a, 102b, 102c to roam between different ASNs and/or different core networks. The PMIP-LMA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Systems, methods, and instrumentalities are disclosed to configure a mobile node, which may include configuring a logical interface (LIF) associated with the mobile node. A mobile node may receive a configuration message. The configuration message may be received from an access network discovery and selection function (ANDSF), which may be part of an open mobile alliance device management (OMA DM) server. The configuration message may comprise a mobile node rule. For example, the configuration message may indicate how the mobile node is to handle an incoming flow or an outgoing flow (e.g., an interface to use, a processing method, etc.). The configuration message may be an open mobile alliance device management (OMA DM) message. The configuration message may be based on feedback from the mobile node. The configuration message may comprise an action and a parameter.

The mobile node may change a configuration in accordance with the mobile node rule. The mobile node rule may indicate that the mobile node is to transmit uplink packets on a certain interface. The mobile node may transmit an uplink packet over the interface indicated by the mobile node rule. As an example, before receiving the configuration message, the mobile node may have been configured to transmit uplink packets on a physical interface on which an associated downlink packet was received. In response to the received configuration message, the mobile node may transmit uplink packets on a physical interface that is different than the one on which an associated downlink packet was received.

Configuration of the mobile node may be implemented by an anchor node, such as a local mobility anchor (LMA). OMA DM server functionality may be implemented at the anchor. The mobile node rule in the configuration message may agree with a related anchor node rule or may be different than the related anchor node rule.

The mobile node rule may be one of a plurality of mobile node rules. The plurality of mobile node rules may be prioritized. For example, the prioritization may be based on one or more of the following: a data type, a time of day, or a cost.

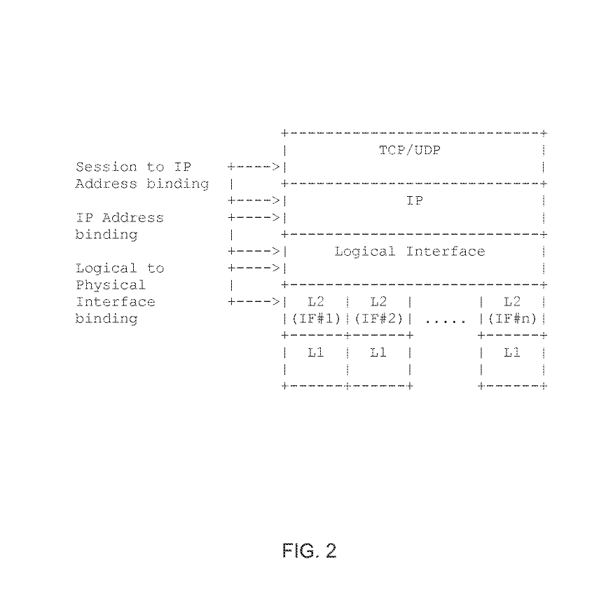

An Internet Protocol (IP) stack may be referred to as a software implementation of the IP suite. A logical interface (LIF) may refer to a construct internal to an operating system. In an LIF implementation, the link-layer may hide the physical interfaces from the IP stack and from network nodes. An example of a logical interface implementation on a mobile network is illustrated by the diagram of FIG. 2.

Network-based IP flow mobility may initiate when an anchor, such as a local mobility anchor (LMA), decides to move a particular flow from its default path to a different path. The anchor may decide which access gateway (AG) (e.g., a mobile access gateway (MAG)) should be used to forward a particular flow when the flow is initiated. For example, the decision may be based on application policy profiles and/or during the lifetime of the flow upon receiving a network-based or a mobile-based trigger. It has been specified that the logical interface transmit uplink (UL) packets on the physical interface on which the downlink (DL) packet was received for the particular prefix/flow. One or more of the following may apply. A flow mobility decision taken at the anchor may be understood at the mobile node (MN) as an implicit decision when packets belonging to the same flow will arrive at a new interface. A mobile node may be, but is not limited to, a user equipment (UE). Control messages are not exchanged to control the IP flow mobility between the mobile and the anchor or between the mobile and the access gateway. In the case that multiple IPv6 prefixes are used, new PMIP or GTP messages may need to be created. These messages may be sent by the anchor to create, refresh, or cancel flow mobility state in the access gateway.

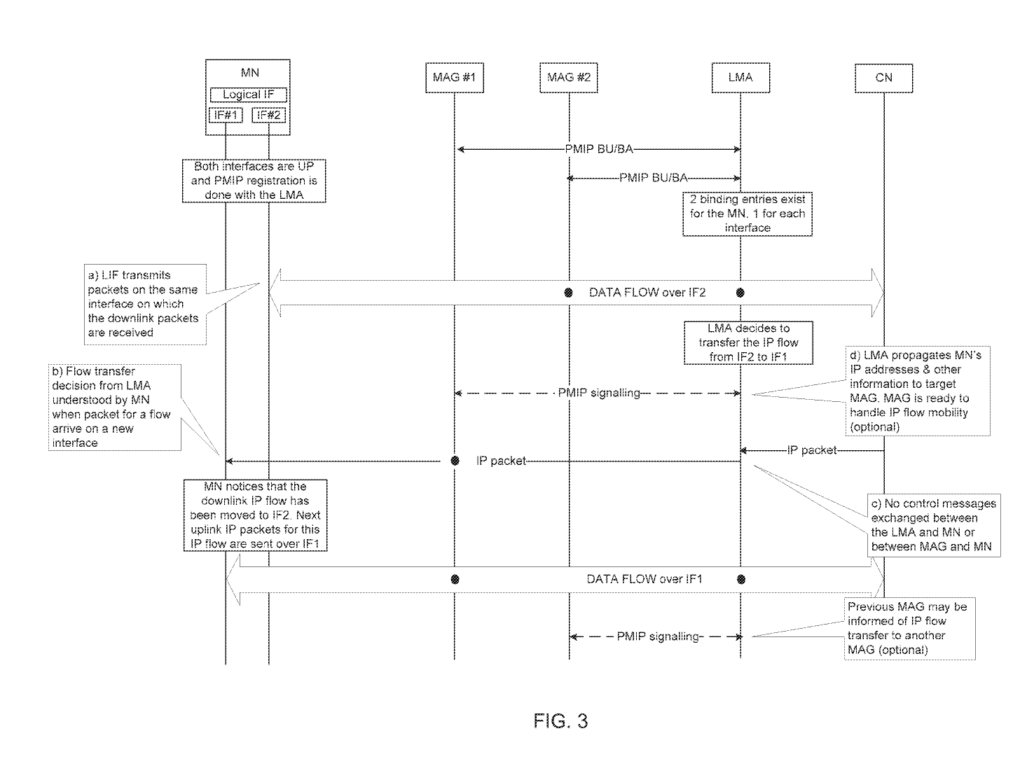

FIG. 3 illustrates an exemplary flow diagram of a network-controlled IP flow mobility sequence, where the decision is from the local mobility anchor (LMA). In FIG. 3, CN represents a correspondent node (CN), and mobile access gateway (MAG) represents a mobile access gateway. When the mobile node is limited to supporting single-radio operation, one radio transmitting at a time, attachment to different MAGs over different media may be sequential (e.g., not simultaneous or somewhat simultaneous). In this case, layer 2.5 signaling may be used to perform the inter-access technology handover and communicate to the LMA the desired target access technology, MN-ID, flow-ID, and prefix.

Policy configuration may occur upon network attachment and be transferred to the MN by means of layer two signaling or dynamically via an external channel. It may be assumed, for example, that L2 signaling may carry such information and that PMIPv6 signaling may convey the routing policies from/to the LMA to/from the MAG. An update of policies may occur during the lifetime of a binding connection. Update of the policies may result in moving ongoing flows from one access network to another access network.

For UL flows, it may be assumed that the MN may configure local policies based on user preferences, operator policies, application requirements, and the like. It may be assumed that the MN is capable of transmitting policies to the MAG, e.g., either during network attachment or upon reception of specific layer two triggers (e.g., link going down). In this case, the MN may be said to trigger the flow mobility procedure. It may be assumed that the network can equally start a flow mobility procedure, based for instance on network load conditions.

IEEE standard 802.21 signaling may be used to carry filters from the MN to the MAG (IETF standardized IP transport for MIH packets). MIH Point of Service may be deployed together with the MAG functionality.

Dynamic exchange of rules between the MN and the anchor may be implemented by, for example, the MN sending rules to the serving node during network attachment or upon a layer 2 trigger (e.g., link going down). Behavior may be limited by applying the same rule on the MN and anchor as specified.

The open mobile alliance device management (OMA DM) specification may relate to management of small mobile devices such as mobile phones, PDAs, and palm top computers, etc. The communication protocol may be a request-response protocol. The communication may be initiated by an OMA DM server, which may be done asynchronously, using any of the methods available, such as a WAP Push, SMS, etc. The initial message from server to client may be in the form of a notification, or alert message. Once communication is established between the server and client, a sequence of messages may be exchanged to complete a given device management task.

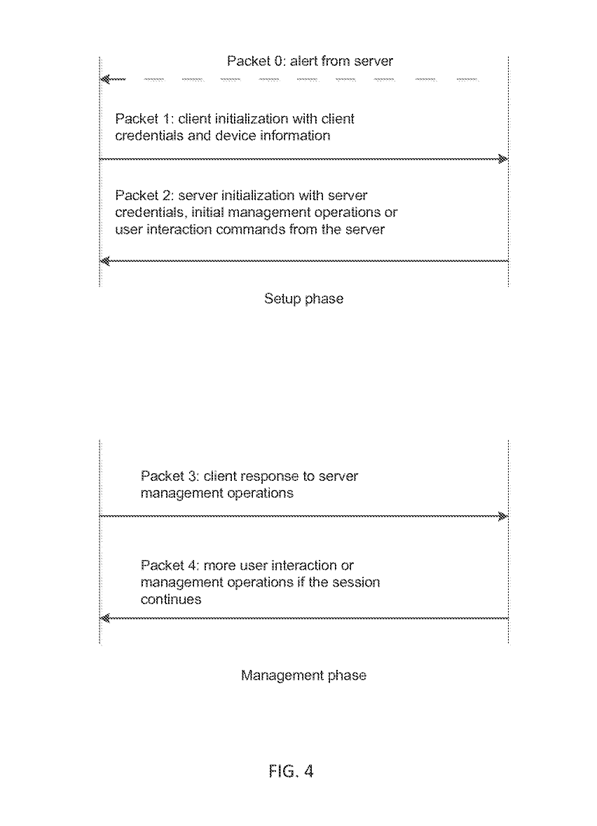

OMA DM may provide for alerts, which may be messages that occur out of sequence, and can be initiated by server and/or client. Such alerts may be used to handle errors, abnormal terminations, and the like. FIG. 4 illustrates an exemplary flow diagram of phases of a device management protocol. A notification message, alert, may be used to provide a possibility for the server to alert the client to perform a management session. A client may initiate a session. Notifications may be sent by the server to inform the client to initiate a session. A client may decide on its own to initiate a session. A notification message may include a trigger header and a trigger body. The trigger header may specify a user interaction mode (ui mode) and may include one or more of the following values: (1) not specified; (2) background management action; (3) informative management action; and (4) user interaction before the management action; etc. The trigger body may be vendor specific (TLV or other type of representation).

Management objects may be disclosed herein that may be used by the access network discovery and selection function (ANDSF) and the UE. The management objects (MO) may include relevant parameters for intersystem mobility policy and access network discovery information that may be managed by the ANDSF. Shown below is an example summary of possible configuration related to IP flow mobility and routing rules.
5.102E<X>/ISRP/44
5.102F<X>/ISRP/<X>44
5.102G<X>/ISRP/<X>/RulePriority 44
5.102H<X>/ISRP/<X>/ForFlowBased 45
5.102I<X>/ISRP/<X>/ForFlowBased/<X>/45
5.102J<X>/ISRP/<X>/ForFlowBased/<X>/IPFlow45
5.102K<X>/ISRP/<X>/ForFlowBased/<X>/IPFlow/<X>/45
5.102L<X>/ISRP/<X>/ForFlowBased/<X>/IPFlow/<X>/AddressType 45
5.102M<X>/ISRP/<X>/ForFlowBased/<X>/IPFlow/<X>/StartSourceIPaddress 46
5.102N<X>/ISRP/<X>/ForFlowBased/<X>/IPFlow/<X>/EndSourceIPaddress 46
5.102O<X>/ISRP/<X>/ForFlowBased/<X>/IPFlow/<X>/StartDestIPaddress 46
5.102P<X>/ISRP/<X>/ForFlowBased/<X>/IPFlow/<X>/EndDestIPaddress 46
5.102Q<X>/ISRP/<X>/ForFlowBased/<X>/IPFlow/<X>/ProtocolType 47
5.102R<X>/ISRP/<X>/ForFlowBased/<X>/IPFlow/<X>/StartSourcePortNumber 47
5.102S<X>/ISRP/<X>/ForFlowBased/<X>/IPFlow/<X>/EndSourcePortNumber 47
5.102T<X>/ISRP/<X>/ForFlowBased/<X>/IPFlow/<X>/StartDestPortNumber 47
5.102U<X>/ISRP/<X>/ForFlowBased/<X>/IPFlow/<X>/EndDestPortNumber 48
5.102V<X>/ISRP/<X>/ForFlowBased/<X>/IPFlow/<X>/QoS 48
5.102W<X>/ISRP/<X>/ForFlowBased/<X>/RoutingCriteria 48
5.102X<X>/ISRP/<X>/ForFlowBased/<X>/RoutingCriteria/<X>/48
5.102Y<X>/ISRP/<X>/ForFlowBased/<X>/RoutingCriteria/<X>/ValidityArea 48
The ValidityArea node may act as a placeholder for location conditions for a particular intersystem routing policy rule.
5.102Z<X>/ISRP/<X>/ForFlowBased/<X>/RoutingCriteria/<X>/TimeOfDay 49
The TimeOfDay node may act as a placeholder for day condition for a particular intersystem routing policy rule.
5.102AA<X>/ISRP/<X>/ForFlowBased/<X>/RoutingCriteria/<X>/APN 49
The APN leaf may indicate the APN for which a particular intersystem routing policy rule is valid.
5.102AB<X>/ISRP/<X>/ForFlowBased/<X>/RoutingRule 49
The RoutingRule node may indicate the preferred access for an Intersystem routing policy rule. This node and its descendants may be as defined in
<X>/Policy/<X>/PrioritizedAccess.
5.7 <X>/Policy/<X>/PrioritizedAccess 14
The PrioritizedAccess node may indicate the preferred access for a particular rule.
5.8 <X>/Policy/<X>/PrioritizedAccess/<X>14
This interior node may act as a placeholder for one or more prioritized accesses.
5.9 <X>/Policy/<X>/PrioritizedAccess/<X>/AccessTechnology 14
The AccessTechnology leaf may indicate a prioritized access technology.
5.10 <X>/Policy/<X>/PrioritizedAccess/<X>/AccessId 15
The AccessId leaf may represent an access network identifier.
5.10A <X>/Policy/<X>/PrioritizedAccess/<X>/SecondaryAccessId 15
The SecondaryAccessId leaf may represent a secondary access network identifier.
5.11 <X>/Policy/<X>/PrioritizedAccess/<X>/AccessNetworkPriority 15
The AccessNetworkPriority leaf may represent an access technology priority.

Internet control message protocol (ICMP) is part of the Internet Protocol Suite. ICMP messages may be generated in response to errors in IP datagrams or for diagnostic or routing purposes. In an example, when an interface becomes enabled, hosts may send out router solicitations that request routers to generate router advertisements immediately rather than at their next scheduled time. Routers may advertise their presence together with various link and Internet parameters either periodically, or in response to a Router Solicitation message. Router advertisements may include prefixes that are used for on-link determination and/or address configuration, a suggested hop limit value, and the like. Echo request/echo reply messages may be used to ping a peer.

DHCP operations may include one or more of the following phases: IP discovery, IP lease offer, IP request, and IP lease acknowledgement. The client may broadcast messages on the physical subnet to discover available DHCP servers. A DHCPDISCOVER message may be used. When a DHCP server receives an IP lease request from a client, it may reserve an IP address for the client and extend an IP lease offer by sending a DHCPOFFER message to the client. A client may receive DHCP offers from multiple servers, but may limit acceptance to one DHCP offer and broadcast a DHCP request message. When the DHCP server receives the DHCPREQUEST message from the client, the configuration process may enter a final phase. The acknowledgement phase may involve sending a DHCPACK packet to the client.

Using a DHCP Information message, a DHCP client may request more information than the server sent with the original DHCPOFFER. The client may request repeat data for a particular application. The client may send a request to the DHCP server to release the DHCP information using a DHCP release message and the client may deactivate its IP address.

A DHCP server may provide optional configuration parameters to the client. A DHCP client may select, manipulate, and overwrite parameters provided by a DHCP server. Configuration parameters and other control information may be carried in tagged data items that are stored in the ‘options’ field of the DHCP message. The data items themselves may be called “options.”

LIF requirements may state that the MN send UL packets on the same interface on which the DL packets were received. To achieve this behavior, incoming packet filtering on the MN may be performed to build a mapping table with the incoming flows and associated interfaces. This incoming filtering may be CPU demanding and may lead to packet drop in conditions where many DL packets are received and incoming filtering is slowing the reception process.

In the above LIF behavior, the LIF implementation on the UE is mirroring the network interface choice per flow. However, it may be advantageous in some situations for the UE to behave differently, e.g., send UL packets on a different interface than the DL packets. A dynamic configuration capability may be needed to support functions (e.g., IP flow mobility) since flows may need to be moved based on real-time situations (e.g., network conditions).

An application that is opening multiple sockets to transfer different types of data may have multiple IP flows. Using the LIF and an anchor node in the network, these IP flows may be moved between the physical interfaces associated with the LIF. The IP flows related to a single application may be treated separately, e.g., they may be moved independently or somewhat independently. For example, an application having three IP flows may have the three flows sent on a single interface (e.g., IF#1) and at some point, end-up with one flow on three different interfaces (e.g., IF#1, IF#2, and IF#3). Such changes may occur for different reasons, e.g. network congestion, network decisions, configured rules, preferences, and the like. Data received by the application in this case may be out-of-sync. Even if the flows are independent, showing and/or playing their content in a synchronous manner may be required.

Logical interface enhancements may be provided based on configured rules, e.g., instead of on predetermined behavior. Such use of configured rules may allow avoiding incoming packet filtering. Rules may be dynamically configured on the MN and/or on the network. The disclosed systems, methods, and instrumentalities may relate to OMA DM, 802.21, DHCP, ICMP, etc. Configured rules on the network/anchor (e.g., downlink) may be different than rules on the MN (e.g., uplink). More than one rule may be applied at the same time (e.g., combinations). The configuration of rules may be dynamic, e.g., to adapt to different situations such as network conditions, time of the day, etc. Application and/or session mobility may be provided. The disclosed systems, methods, and instrumentalities may relate to LIF behavior in a network-based mobility domain (e.g. PMIP or GTP), and, related network nodes may be part of PMIPv6 or GTP domains.

Packet filtering on the MN may be avoided by making a rule to be applied on the outgoing packets known to the MN. For example, if the rule applied by the anchor is known by the MN, the MN may not have to perform incoming packet filtering (e.g., to determine what interface to use in the UL) since the MN would know the rule that the MN is to use. Instead of requiring the MN to inspect incoming packets and then mirror the behavior with outgoing packets, the rule to be applied may be configured on the MN. In addition, the LIF behavior may be flexible (e.g., in contrast to being required to send packets on the interface on which the flow was received).

The following may provide dynamic rule configuration examples. Configurations may be changed in accordance with rules (e.g., such as the types of rules described herein). An anchor may be sending two flows (e.g., flow#1 and flow#2) to a MN on the downlink on a certain interface (e.g., interface#1 (IF#1)). The MN may be configured (e.g., by a rule) to send UL packets related to a flow on the interface on which it received downlink packets for the flow. That is, the MN may send UL packets for flow#1 and flow#2 on IF#1 in accordance with the rule, and without performing packet filtering on incoming packets from flow#1 and flow#2. The anchor may change the configuration of the MN. For example, the anchor may send a new rule to the MN that configures the MN to send uplink packets associated with flow#1 on IF#1 and uplink packets associated with flow#2 on IF#2. The rule sent to the MN may be the rule that is being followed by the anchor. In such a case, and continuing the above example, the anchor may send flow#1 to the MN on IF#1 and flow#2 to the MN on IF#2. The rule sent to the MN may be different than a rule that is being followed by the anchor. In such a case, and continuing the above example, the anchor may send flow#1 and flow#2 to the MN on IF#1. In accordance with a MN rule that is different than the anchor rule, the MN may send flow#1 packets on IF#1 and flow#2 packets on IF#2; that is, the MN may send UL packets according to its configuration (e.g., in accordance with its configured rules) without performing packet filtering on incoming packets.

Rule configurations may be performed by the anchor to the MN. In the case where the MN dynamically configures rules on the anchor, the MN may control the flow transport (e.g., MN-controlled IP flow mobility, MN-controlled interface handover, and the like).

Dynamic configuration of rules may provide adaptation to different situations, e.g., network conditions, time of the day, and the like. A protocol that offers the possibility to push (e.g., send notifications) may be used by the MN or by the anchor. A controlling entity in the network may be involved during the exchange of information. The serving node (e.g., MAG) may be used for such an exchange. As examples, the rules may be transmitted via methods provided in OMA DM, DHCP, ICMP, 802.21, IKEv2, IPCP, and the like.

OMA DM may be modified to dynamically configure rules, e.g., from the MN to the network or from the network to the MN. OMA DM server functionality may be implemented at the anchor, serving node, external OMA DM server (e.g. ANDSF), etc.

ANDSF may push rules to the MN and/or anchor/serving node. The anchor may push rules to serving node (or vice-versa), using, for example, a network specific protocol (e.g., PMIPv6, GTP, etc.) or OMA DM, which may forward them to the MN using OMA DM. OMA DM may be used during initial configuration of rules on the MN and network and/or may be used for dynamic configuration of rules.

Relating to notification (push), a new mode may be provided to be configured in the trigger header/user interaction mode—ui mode. A new value may be provided to state that a configuration is ready to be read (e.g., read immediately—immediate management action). For the ready to read case, information may be ready to be retrieved and a management session may need to be established. A new value may be provided to state that information is included in a trigger body/vendor specific field. Management action may not be required and/or there may not be a need to establish a management session when this message is received since the information is carried within the message itself.

A format for rules may be provided to be carried in a trigger body/vendor specific field. As an example, the rule may follow the following format: ACTION+RULE+PARAMS. ACTION may specify to add, modify, or delete. A rule may specify that TLV or other type of representation may be used. For example, an action may be sent (add, modify, delete) with an associated rule. Rules may be numbered, and, exchanges during dynamic configuration may be limited to number(s).

The following are examples of rules that may be configured: 1=Send IP flow on same interface as received; 2=send a certain IP flow on IF#X; 3=Send TCP ACKs on IF#X; 4=Send control messages on IF#X; 5=Send IP flow on a fastest interface; 6=Send IP flow on a cheapest interface; 7=Use windowing method; 8=Use a hysteresis window, etc. Rules may be named (e.g., string instead of number).

The following are examples of PARAMS. A PARAM may be a 5-tuple (e.g., IP source address, IP destination address, IP source port, IP destination port, protocol type). A PARAM may be a 6-tuple, for example if IPv6 is used (e.g., 5-tuple+IP flow level). A PARAM may be a value, which may depend on the configured rule, e.g., window size value if configured rule=windowing method or hysteresis window. A PARAM may be an interface identifier, e.g., if the rule is for example 2, 3, or 4 as specified above. A PARAM may be another field that may be checked for packet filtering. This may not be limited to a TCP/IP header.

One or more encoding modification may be needed. The existing category may include: <X>/ISRP/<X>/ForFlowBased/<X>/RoutingRule/<X>/

Fields may be added, which may include one or more of the following:

<X>/ISRP/<X>/ForFlowBased/<X>/RoutingRule/<X>/ConfiguredRule Values: <may be as defined for “RULE,” as disclosed herein, e.g., 1-8>

<X>/ISRP/<X>/ForFlowBased/<X>/RoutingRule/<X>/Params

<X>/ISRP/<X>/ForFlowBased/<X>/RoutingRule/<X>/Params/WindowSize

<X>/ISRP/<X>/ForFlowBased/<X>/RoutingRule/<X>/Params/HysteresisValue.

Access types for added fields (e.g., as specified for “ACTION”) may include, but are not limited to: add, delete, and replace. The tuple identifying an IP flow may be defined in <X>/ISRP/<X>/ForFlowBased/<X>/IPFlow/<X>/and may not need to be added in the routing rules.

ICMP may be used to exchange LIF rules between the MN and the anchor. ICMP messages may be defined for that purpose. RS/RA/Echo messages may carry rules. Rules may be added to ‘options’ in accordance with the standard. Embodiments may be backward compatible with the current version of ICMP, e.g., the introduced option may be skipped if not supported.

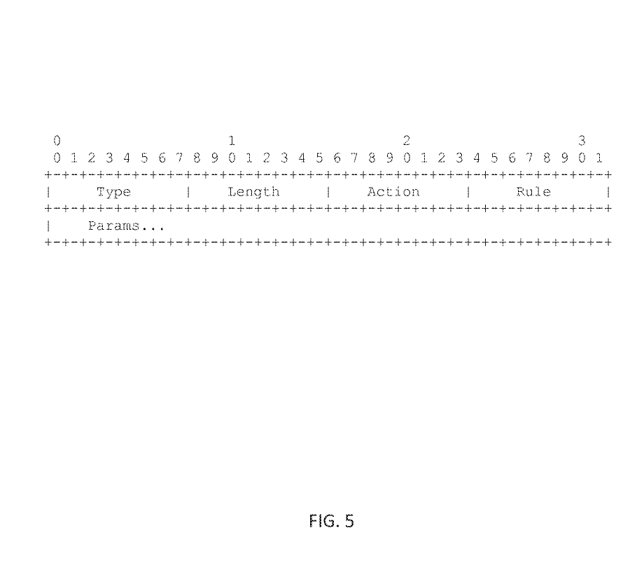

An option called ‘rule’ may be provided. This option may be used to configure LIF rules either on the MN or on network nodes. An exemplary format of the rule option is described herein, e.g., rule format: ACTION+RULE+PARAMS. FIG. 5 illustrates an exemplary encoding format. An encoding example, such as that shown in FIG. 5, may include one or more of the following fields: Type—a number not already used for another option, e.g., 6; Length—variable, depending on the params length; Action—1-3 (e.g., as disclosed herein); Rule—1-8 (e.g., as disclosed herein); Params—variable, may depend on the rule (e.g., as disclosed herein). The rule option may comprise multiple actions, rules, and/or params. This option may be used for example by the filter messages, the RS/RA messages, the echo messages, etc.

Following are examples of ICMP messages. A filter message may be sent by the MN to the anchor or by the anchor to the MN to add, modify, or delete rules. The filter message may comprise the option called ‘rule,’ as disclosed herein. A filter reply message may be sent as a response to the filter message. The filter reply message may comprise filters that have been accepted from the request message.

Updated router solicitation and/or router advertisement messages (RS/RA) may be disclosed. The option may be added to the RS/RA to convey LIF rules to be applied locally (e.g., either on the MN or on the anchor). If the MN does not have an IP address, the RS may be sent to routers. The options may comprise the MN's LIF rules. The RA message received by the MN may comprise LIF rules in the option(s). These rules may be rules configured by the network or rules specified by the MN on the RS and that are accepted. If the MN's IP address has been obtained, the RS message may be used to modify the LIF rules (MN controlled). In such a case, the RS message may be sent to the anchor (or network node from which the local IP address has been obtained), e.g., destination IP address=anchor IP address. The associated RA may be sent to the MN, e.g., destination IP address=MN's IP address from the RS.

Echo request and/or echo reply messages may be used. These messages may be modified to carry options, e.g., in addition to the data field. The options field may be defined as disclosed herein.

An option called “flow filter” may be provided. Flow filter may specify filters applied to obtain IP flow mobility. The rule format as disclosed herein may be used, e.g., ACTION+RULE+PARAMS. It may include a list of rules and/or related parameters that may be used to determine on which interface outgoing packets should be sent. Fields used for packet filtering may be specified in the PARAMS field (e.g., 5-tuple and the desired outgoing interfaces).

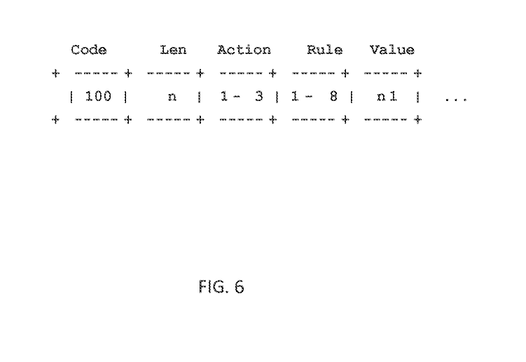

FIG. 6 illustrates an exemplary encoding format. This is an example of how the rule format may be defined. Other formats may be chosen to achieve similar behavior (e.g., a list of actions, which may be encoded, in addition to a list of rules). As illustrated in FIG. 6, the rule format may be: Rule format=CODE_FLOW_FILTER LEN ACTION RULE PARAMS.

In the example of FIG. 6:
CODE_FLOW_FILTER=100;
Len=n (where n may represent a length);
Action may be a value, e.g., a number, where the number may represent an action, e.g., a range of 1-3 may be provided where Add=1, Modify=2, and Delete=3; Rule may be a value, e.g., a number, where the number may represent a certain rule, which may be associated with a Param and/or length as illustrated in Table 1.

TABLE 1

| Rule | Params | Length |
|---|---|---|
| 1 = Send IP flow on same interface as received | n/a | 0 |
| 2 = send this IP flow on IF X | Interface id | 1 |
| 3 = Send TCP ACKs on IF X | Interface id | 1 |
| 4 = Send control messages on IF X | Interface id | 1 |
| 5 = Send IP flow on fastest interface | n/a | 0 |
| 6 = Send IP flow on cheapest interface | n/a | 0 |
| 7 = Use windowing method | Window size | 1 |
| 8 = Use an hysteresis window | Window size | 1 |

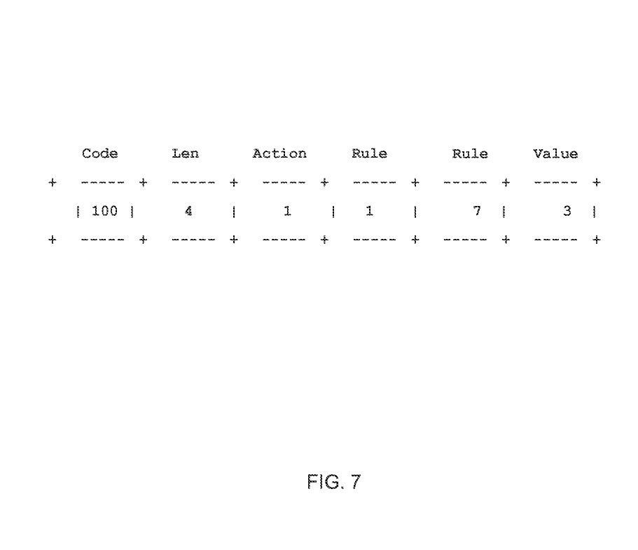

FIG. 7 illustrates an exemplary rule format that adds two rules. In FIG. 7, following the above examples, action is listed as 1 indicating an add action. There are two rule indicators. The first rule indicator is listed as 1, which indicates that an IP flow is to be sent on the interface on which it was received. The second rule indicator is listed as 7, which indicates winnowing method use. The second rule is followed by a value indication listed as 3, which indicates that window size is 3. The rule format may be changed in various ways as illustrated by the example of FIG. 7.

Messages, such as DHCPDISCOVER, DHCPOFFER, DHCPREQUEST, DHCPACK, DHCPINFORM, etc., may be used to transport rules in an IPv4 environment. The following examples are illustrative. A DHCPDISCOVER message may specify rules using options such as those disclosed herein (e.g., MN controlled). A DHCPOFFER message may transport rules using options such as those disclosed herein (e.g., either MN rules that are accepted (rejected rules not included) or anchor rules). A DHCPREQUEST message may transport rules using options such as those disclosed herein (e.g., either modified rules (MN controlled) or accepted rules received from Anchor on DHCPOFFER). These may be sent when the MN needs to modify a rule. For example, there may be no need to wait for a DHCP renewal trigger. A DHCPACK message may comprise rules that have been transported using DHCPREQUEST or DHCPINFORM and that have been accepted by the anchor. This may comprise anchor rules. Rejected rules may not be included. The DHCP server may configure new/modified rules using a DHCPACK message. In this case, the MN may send back a DHCPREQUEST or DHCPINFORM comprising the rules that have been accepted. Rejected rules may not be included. A DHCPINFORM message may specify rules using options such as those disclosed herein (e.g., MN controlled).

The use of DHCP in an IPv6 environment may make use of different messages. The following are illustrative messages that may carry options as disclosed herein. A DHCPSOLICIT message may specify rules using the options (e.g., MN controlled). A DHCPADVERTISE message may transport rules using the options (e.g., either MN rules that are accepted (rejected rules may not be included) or anchor rules). DHCPREQUEST/DHCPRENEW/DHCPREBIND messages may transport rules using options such as those disclosed herein (e.g., modified rules (MN controlled) or accepted rules (received from anchor on DHCPADVERTISE or DHCPREQUEST)). The message may be sent when the MN has to modify a rule. A DHCPREPLY message may comprise rules configured by the MN that have been accepted by the anchor, and may not include rejected rules. This message may comprise anchor rules. The DHCP server may configure new/modified rules using a DHCPRECONFIGURE message. In this case, the MN may send back a DHCPRENEW or DHCPINFORMATION-REQ comprising the rules that are currently used. The DHCP server may then send back the rules to be configured using a DHCPREPLY message. A DHCPINFORMATION_REQ message may specify rules using options such as those disclosed herein (e.g., MN controlled).

The DHCP server may be co-located with a serving node. The rules may be transmitted between serving node and anchor node (e.g., using PMIPv6 or GTP). The MN may act as DHCP client. The DHCP server may be co-located with an anchor node, where rules may be forwarded by the anchor to serving node (e.g., using PMIPv6 or GTP). The MN may act as DHCP client. The DHCP server may be implemented in an external node, where the MN and the anchor may act as DHCP clients to obtain and/or configure rules. The serving node may use DHCP to interact with the DHCP server directly or may interact with the anchor (e.g., using PMIPv6 or GTP).

IEEE standard 802.21 may be used to transport rules between the MN and the network. This may be implemented in several ways, e.g., using command services (CS), event services (ES), information services (IS), etc. An MIH server handling CS, ES and/or IS may be located in a separate node (e.g., ANDSF) on the network or may be co-located with the anchor (e.g., LMA) or serving node (e.g., MAG). IEEE standard 802.21 may be used to dynamically configure rules, e.g., from the MN to the network and/or from the network to the MN. In an example, IEEE 802.21 signaling may be used to carry filters from the MN to the MAG.

Combinations of messages disclosed herein may be utilized. For example, combinations of CS, ES, IS, etc. may be used. Regarding command services, the message MIH_Link_ConfigureThreshold request/response may be used to configure rules. Some modifications in the parameters may be required. For example, the LINK_PARAM_TYPE may be modified to accept an additional type of parameter, e.g., LINK_PARAM_LIF_RULE. LINK_TYPE may be modified to accept “all” as a valid value. Additional messages may be introduced, e.g. MIH_Set_Parameters request/response, e.g., the LINK_PARAM_TYPE modified to support LIF rules.

Regarding information services, an MIH_Push_Information indication message may be used to transport LIF rules. This message may be used by the MN or the network to push the rules dynamically on the network or MN respectively. MIH_Set_Information request/response messages may be added. These messages may be similar to the existing MIH_Get_Information request/response messages except that a SET may be done instead of a GET.

A combination of these messages may be used if, for example, a separate node in the network is used to implement the 802.21 IS. Examples may include the following. If the anchor wants to configure rules on the MN, an MIH_Set_Information request may be used to set the information on the 802.21 IS node. This node may then use an MIH_Push_Information indication to configure the rule on the MN. An anchor node may use the MIH_PushInformation indication to configure a LIF rule on an independent node which may use an MIH_Push_indication to inform the MN that new configuration elements are available. The MN may query the network node using the existing MIH_Get_Information request with new parameters to query LIF rules. An MIH_Get_Information response may be modified to carry LIF rules.

Regarding event services, an MIH_Link_Parameter_Report indication may be used to transport LIF rules. New messages may be introduced, e.g., MIH_New_Config indication.

LIF behavior may be enhanced by applying different rules on the MN and on the anchor. For example, the anchor may have a rule stating that downlink packets be sent on IF#1 (e.g., for a given flow), while the MN may be configured with a rule stating that uplink packets be sent on IF#2 (e.g., for the flow).

Multiple rules (e.g., a plurality) may be combined. The multiple rules may be prioritized. The rules may be used in accordance with the prioritization. Following are examples using multiple rules. A rule, such as a rule to send uplink packets on the interface on which downlink packets are received, may be combined with the windowing mechanism described herein. The window size may be configured at the same time as the associated rule.

Multiple rules may relate to different types of information. A rule, such as a rule that control packets be sent on a most reliable interface (e.g., IF#1) may be combined with a rule that data be sent on a fastest interface (e.g., IF#2). These rules may be applied on the MN and/or the anchor.

Rules may be prioritized based on types of transmissions. A rule may provide prioritization such that retransmission (e.g., performed by TCP layer) be sent on a most reliable link, while regular traffic be sent on a fastest or cheapest link. Such a rule may be configured on the MN and/or anchor.

Rules may be prioritized based on a a time (e.g., time of day) and/cost (e.g., cost to send information). A rule may provide prioritization such that from 9:00 AM to 5:00 PM packets be sent on a fastest interface (e.g., IF#1), while for the rest of the day packets be sent on a cheapest interface (e.g., IF#2). This may be done, for example, to use the fastest and/or free link while at work and switch to the cheapest link while not at work.

A rule may state that a node send packets on the interface on which it received associated packets (e.g., a mirroring rule). Such a rule may be applied to a MN and/or an anchor. The following are examples. An anchor may be may be configured with a rule that it send downlink packets on the interface on which it received uplink packets. This rule may be limited to configuration on the anchor. Such a rule may enable MN-controlled IFOM without requiring signaling messages, e.g., MN decides where to send the packets and anchor follows MN decisions.

Logical interface behavior may be used to enable IP flow mobility. For example, IP flows may be moved independently from one interface to another without applications noticing that movement. The logical interface may hide from the higher layers that the interface is changing. Flows may be glued together such that when a flow is moved, the glued flows may be moved in the same way. Glued flows may be, for example, the flows associated with an application or a subset of the flows associated to an application (e.g., an application may have 3 active flows with two of them glued together and the other one being independent).

The network may determine when a flow is to be moved, which interface it should be moved to, which other flows are to be moved at the same time (e.g., glued flows), etc. The LIF module implemented on the MN may wait to mirror the network decision. The LIF module may wait for a certain period of time before applying the flow movement to the uplink packets to give a chance for glued flows to be moved on the incoming direction and then to apply the outgoing interface change to the impacted flows at the same time. The LIF module may not need to be aware of which flows are glued together. In such a case, the need for that knowledge may be limited to the network since the LIF module on the mobile may be mirroring the movements initiated by the network. If the LIF module on the mobile knows which flows are glued together, it may mirror the flow movement for the flow that has moved and autonomously initiate the same movement to the glued flows. The above procedures may be applied with the roles reversed between the mobile and network.

The network and the mobile may have the capability to initiate flow movements. Conflict resolution may be provided. The network may require the movement of a flow (e.g., flow#1) to a specific interface X while the mobile requests the movement of another flow that is glued to flow#1 (e.g., flow#2) to a different interface Y (e.g., where a movement decision is allowed from mobile and network). In this case, priorities may be given to the mobile or to the network, and, for example, the network may have the final decision on movement. The priorities may be configured into the policies. In this example, the network may have priority. For the case described above, flow#1 would be moved to interface X while the movement of flow#2 to interface Y would be rejected since these two flows are glued and since the network has the priority over the mobile in this example.

A technique may be implemented to accept the first flow movement and reject the conflicting subsequent ones. The timestamp in the IP packets may be used to determine which flow movement is the first one.

Identification of glued flows may be provided. IP flows may be identified in many ways. The 5-tuple may be used: IP source address, IP destination address, source port, destination port and protocol. Other fields may be used and may be configured by policies. The discussion below may assume that the 5-tuple is used to identify IP flows.

Flow gluing may be performed on the mobile side. Flows may be glued together by applications or by a flow management entity on the mobile. If the applications are flow-aware, they may specify a field(s) when opening a socket to identify themselves (e.g., applicationID) and the flow group (flowGroup) that may be associated with the socket or to this 5-tuple. The LIF module may be configured with this information and integrate it into its existing mapping table. For example, Table 2 is an exemplary LIF mapping table where the first two identified flows may be glued (rows 2 and 3 of Table 2).

TABLE 2

| | | Flow identifier | Incoming | Outgoing |
|---|---|---|---|---|
| ApplicationID | FlowGroup | (5-tuple) | interface | interface |
| Appl-X | 1 | 5-tuple A | IF#1 | IF#1 |
| Appl-X | 1 | 5-tuple B | IF#2 | IF#2 |
| Appl-X | 2 | 5-tuple C | IF#2 | IF#2 |
| Appl-Y | 1 | 5-tuple D | IF#1 | IF#1 |

The applications may configure their flows using another interface than the socket API. A flow management entity may export a function, e.g., FlowConfig(ApplicationID, FlowGroup), that may be called by applications to dynamically configure their flows. The LIF module may export a configuration function, e.g., LIF_FlowConfig(ApplicationID, FlowGroup). If the application is a legacy application that is not flow-aware, flows may be glued based on the destination IP address, which may identify the content provider. In this case, flows going to the same destination would be glued together.

Flow gluing may be performed on the network side. The flow movement controlling node on the network side may not have information about the application by looking at the IP packets. It may know the source IP address but this may not identify the application. To be able to associate a flow with an application and then glue flows together, the network node may need to receive information prior to examining the IP packets. This additional information on the applications/flows may be received via a configuration mechanism from the mobile.

A header may be provided in the IP packets to specify the ApplicationID and FlowGroup. The header may be added between the application data and the transport header (e.g. UDP/TCP). The ApplicationID and the FlowGroup may be specified there. The network node may be able to extract that information and build an internal flow gluing table. The policies may specify if such a header is to be used.

What is claimed:

1. A method to configure a logical interface (LIF) associated with a mobile node, the method comprising:
receiving a configuration message from an access network discovery and selection function (ANDSF), wherein the configuration message comprises a mobile node rule, and wherein the configuration message is an open mobile alliance device management (OMA DM) message;
changing a configuration of the mobile node in accordance with the mobile node rule; and
transmitting an uplink packet over an interface indicated by the mobile node rule.

2. The method of claim 1, wherein the interface is different from a downlink interface.

3. The method of claim 1, wherein the configuration message is based on feedback from the mobile node.

4. The method of claim 1, wherein the mobile node rule is different than an anchor node rule.

5. The method of claim 1, wherein the mobile node rule agrees with an anchor node rule.

6. The method of claim 1, wherein the mobile node rule is one of a plurality of mobile node rules.

7. The method of claim 6, wherein the plurality of mobile node rules is prioritized, and wherein the prioritization is based on one or more of the following: a data type, a time of day, or a cost.

8. The method of claim 1, wherein the configuration message comprises an action and a parameter.

9. The method of claim 1, further comprising:
determining a glued flow associated with the uplink packet; and
transmitting the glued flow over the interface indicated by the mobile node rule.

10. A mobile node comprising:
a receiver configured to receive a configuration message from an access network discovery and selection function (ANDSF), wherein the configuration message comprises a mobile node rule, and wherein the configuration message is an open mobile alliance device management (OMA DM) message;
a processor configured to change a configuration of the mobile node in accordance with the mobile node rule; and
a transmitter configured to transmit an uplink packet over an interface indicated by the mobile node rule.

11. The mobile node of claim 10, wherein the interface is different from a downlink interface.

12. The mobile node of claim 10, wherein the configuration message is based on feedback from the mobile node.

13. The mobile node of claim 10, wherein the mobile node rule is different than an anchor node rule.

14. The mobile node of claim 10, wherein the mobile node rule agrees with an anchor node rule.

15. The mobile node of claim 10, wherein the mobile node rule is one of a plurality of mobile node rules.

16. The mobile node of claim 15, wherein the plurality of mobile node rules is prioritized, and wherein the prioritization is based on one or more of the following: a data type, a time of day, or a cost.

17. The mobile node of claim 10, wherein the configuration message comprises an action and a parameter.

18. The mobile node of claim 10, wherein the processor is further configure to determine a glued flow associated with the uplink packet, and wherein the transmitter is further configured to transmit the glued flow over the interface indicated by the mobile node rule.
